(19) United States
(12) Patent Application Publication
(10) Pub. No.: US 2004/0247803 A1
(43) Pub. Date: Dec. 9, 2004

(54) Ink-jet recording paper and a method for producing ink-jet recording paper

(75) Inventor: Yoshinori Tsubaki, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA HOLDINGS, INC.

(21) Appl. No.: 10/855,525

(22) Filed: May 28, 2004

(30) Foreign Application Priority Data
Jun. 3, 2003 (JP) JP2003-157816

(51) Int. Cl. B41M 5/00

(52) U.S. Cl. 428/32.34

(57) ABSTRACT

A method for producing an ink-jet recording sheet comprising the steps of:

(a) coating a liquid coating composition on a support so as to obtain a coated layer, the liquid coating composition containing,

(i) inorganic microparticles; and

(ii) a hydrophilic resin ;

(b) irradiating the coated layer with ionization radiation, wherein illumination intensity of the ionization radiation is in a range of 0.1 to 1000 mW/cm² so as to cross-link the hydrophilic resin when a density of a solid portion in the coated layer is in a range of 5 to 90 weight % based on the total weight of the coated layer; and

(c) drying the coated layer.

### RELATED PREPARATION

This application is based on patent application No. 2003-157816 filed in Japan, the entire content of which is hereby incorporated by reference.

### BACKGROUND

1. Field of the Invention

This invention relates to an ink-jet recording paper, hereinafter simply referred to as a recording paper, and a method for producing thereof, and more in detail, to an ink-jet recording paper having a porous layer, which is difficultly cracked on occasion of the production and is improved in ink absorbability, wet-curl resistivity and resistivity against break by bending, and to a method for producing the recoding paper.

2. Description of the Related Art

Recently, in the ink-jet recording method, the image quality is rapidly improved so as to be near the quality of the image by silver salt photography. In the recording paper to be used for the ink-jet recording, technological improvement is also actively attempted as a measure to attain such the photographic image quality.

A water absorbable support such as paper and a water non-absorbable support such as polyester film and resin coated paper are usually know as the support of the ink-jet recording paper. The former has a problem of occurrence of wrinkles, also called as cocklings, after printing caused by the water absorption of the support even though such the support has a merit of high ink absorbability since the support itself can absorb the ink. Consequently, a high quality image can be difficultly obtained and rubbing of the printed surfaced accompanied with the cockling tends to occur on the occasion of printing.

Contrary, in the case of the water non-absorbable support, the above problems do not occur and a high quality print can be obtained.

Besides, regarding to the ink receiving layer, an ink-jet sheet has been devised which is constituted by coating a hydrophilic binder such as gelatin and (polyvinyl alcohol) on a support having the surface with high smoothness. Such the type of recording paper absorbs the ink utilizing the swelling ability of the binder.

Such the ink accept layer has difficulty of drying of the ink after printing and the image and the layer are weak against moisture and have no water resistivity since the layer is composed of the water-soluble resin. Moreover, in a recent ink-jet printer, the absorbability by the swelling of the binder can not follow the spouting amount or the spouting speed of the ink and over flow of the ink and speckles are caused since the printing speed is high in such the printer.

An image accept layer composed of modified PVA and a water proofing agent is disclosed in Japanese Patent Publication Open to Public Inspection, hereinafter referred to as Japanese Patent O.P.I. Publication, No. 63-18387. In Japanese Patent O.P.I. Publication No. 1-186886, a recording sheet for an aqueous ink having an ink accept layer composed of a hydrophilic resin crosslinked by ionizing radiation is revised. The problem of the water resistivity of the image and the layer is solved, but the ink absorbability is not improved because the ink is absorbed by utilizing the swelling of resin in such the recording layer.

The recording paper such as that disclosed in Japanese Patent O.P.I. Publication No. 10-119423 having a porous ink accept layer including fine pores, has higher ink absorbability and higher drying ability compared to the type of ink-jet recording sheet absorbing the ink by utilizing the welling of the hydrophilic resin. Accordingly, the recording paper having the porous ink accept layer is coming to one method for obtaining the image quality nearest that of the photographic image.

The porous layer is principally composed of a hydrophilic binder and a fine particle. As the fine particle, inorganic and organic fine particles are known. Among them, the inorganic particle is preferably used since it has usually smaller diameter and suitable for realizing the porous layer having high glossiness. When a relatively small amount of the hydrophilic binder concerning such the inorganic particle is used, spaces are formed between the particles and the porous layer with high porosity can be obtained.

The layer absorbs the ink by the capillarity of the pores. Consequently, the absorbing speed is not degraded when the binder is crosslinked by the use of a crosslinking agent to improve the water resistivity. Particularly in the case of the ink-jet recording paper composed of the water non-absorbable support such as polyethylene-coated paper and the porous layer provided thereon, it is necessary to contemporarily held all the ink in the ink accept layer on the occasion of the ink-jet recording. Therefore, the ink accept layer should be a porous layer having high porosity. Consequently, it is necessary to form a thick layer having high porosity. The dry thickness of the layer is usually not less than 25 μm, and preferably from 30 to 50 μm.

When the thick porous layer is coated on the water non-absorbable support, cracks tends to occur on the occasion of the drying since the porous layer is principally composed of inorganic particles and essentially hard.

In the course of the production of the porous layer, a small amount of the hydrophilic binder is adsorbed on the surface of each of the fine particles so as to be locked together or the interaction such as the hydrogen bond between the binder to hold the fine particles and form protective colloid so as to form the porous layer. Thereafter, the coated layer is rapidly shrunk in the drying process, and the cracks occur by the shrinking stress. Such the phenomenon is considerable near the end point of the drying. Therefore, the drying under a mild drying condition is necessary, enduring the lowering of the productivity, to obtain the suitable layer surface without the cracks.

Moreover, it is a problem that the absorption layer is insufficient in the water resistivity since the fine particles are fixed in the layer only by a relative small amount of the binder.

Regarding such the problem, Japanese Patent O.P.I. Publication No. 2001-146068 discloses an ink-jet recording paper which is improved in the water resistivity of layer using boric acid and an isocyanate crosslinking agent, Japanese Patent O.P.I. Publication No. 7-40649 discloses a recording paper using an active energy hardenable monomer as the binder, and Japanese Patent O.P.I. Publication No. 2002-160439 discloses a recording paper using hydrophilic resin crosslinked by electron rays as the binder.

When such the monomer hardenable by the crosslinking agent or the active energy is used as the binder, the water resistivity of layer is improved by the crosslinks in the binder but a problem newly occurs that the softness of the layer is lost and the resistivity of the layer to the break by bending is lowered since dense three dimensional crosslinks is formed in the coated layer.

Moreover, when the hydrophilic resin is crosslinked by electron rays, the irradiation amount of the electron rays is excessively supplied to the hydrophilic binder and the solvent since the specific gravity of the inorganic fine particle is larger than that of the hydrophilic binder. Consequently, a problem comes up that the resistivity to wet curling, also referred to as the dimensional stability, is considerably lowered since the moisture in the coated layer is instantaneously evaporated and forms bubbles which rough the surface of the coated layer, and the irradiation amount of the electron ray is made insufficient at the deep portion of the coated layer so as to form an incline in density of the crosslinks and a hardened layer is only formed at the outer surface.

### SUMMARY

The object of the invention is to solve at least one of the above-described problems.

The object of the invention can be attained by a method for producing an ink-jet recording paper comprising the steps of forming a coated layer by coating at least one layer of a coating liquid containing an inorganic fine particle and a hydrophilic resin crosslinkable by ionizing radiation on a support, irradiating an ionizing radiation having an illuminance of from 0.1 mW/cm² to 1 W/cm² when the solid component concentration is within the range of from 5 to 90%, and then drying the coated layer.

The object of the invention can be also attained by an ink-jet recording paper produced by forming a coated layer by coating at least one layer of a coating liquid containing an inorganic fine particle and a hydrophilic resin crosslinkable by ionizing radiation on a support, irradiating an ionizing radiation having an illuminance of from 0.1 mW/cm² to 1 W/cm² when the solid component concentration is within the range of from 5 to 90%, and then drying the coated layer.

The invention itself, together with further objects and attendant advantages, will best be understood by reference to the following detailed description taken in conjunction with the accompanying drawings.

### DESCRIPTION OF THE PREFERRED EMBODIMENT

The ink-jet recording paper and the producing method thereof according to the invention are described in detail below.

Inorganic Fine Particle

The inorganic fine particle to be used in the invention is a fine particle inorganic pigment having a large pore capacity and a small average diameter. Particularly, fine particle pigment such as silica, aluminum hydroxide, boemite, psoudbaimite, alumina and calcium carbonate are usable.

The silica is wet-method silica produced from sodium silicate as the raw material by a precipitation method or a gelation method, or gas phase-method silica. Examples of the wet-method silica available on the market include Finesil produced by Yamatoku Co., Ltd. by the precipitation method and Nipgel produced by Nihon Silica Kogyo Co., Ltd. by the gelation method. In the silica by precipitation method, primary particles each having a diameter of approximately from 10 to 60 nm form a secondary coagulated particle; and in the silica particle by gelation method, primary particles each having a diameter of approximately from 3 to 10 nm form a secondary coagulated particle.

The diameter of the primary particle of the silica is preferably not less than 3 nm from the viewpoint of stability of the production and not more than 50 nm from the view point of the transparency of the layer, even though lower limit of the primary particle diameter of the wet-method silica is not specifically restricted. Generally, the wet-method silica synthesized by the gelation method is preferred since such the silica usually has the primary particle diameter smaller than that of the silica produced by the precipitation method.

The gas phase-method silica is one synthesized from silicon tetrachloride and hydrogen by burning method such as Aerosil R series produced by Nihon Aerosil Co., Ltd.

For obtaining the ink absorbing layer having high porosity, the silica particle has a specific surface area measured by BET method is less than 100 m² or an isolated silanol group ratio of from 0.5 to 2.0. The lower limit of the specific surface area is 40 m²/g from the viewpoint for obtaining glossiness near photograph. The BET method is a method for measuring the specific surface area by determining the surface area per one gram according to the gas phase adsorption isotherms. The gas phase-method silica having the specific surface area within such the range and a variation coefficient of the primary particle diameter distribution of not more than 0.4 is preferred from the viewpoint of the porosity. Regarding the wet-method silica, however, such the matter is not applied since the primary particle itself has a pores diameter.

The gas phase-method silica has a feature that it can be dispersed by lower energy compared to the wet-method silica since the secondary coagulated particle of the gas phase-method silica is formed by relatively weaker interaction than that in the wet-method silica.

The variation coefficient in the primary particle diameter distribution of the gas phase-method silica is determined by the following procedure: The cross section and the surface of the porous layer are Observed by an electron microscope and the diameters of optionally selected 1,000 primary particles are measured. And the coefficient is defined by the quotient of the standard deviation of the particle diameter distribution divided by the average particle diameter. The diameter of individual particle is represented by the diameter of a circle having the area the same as the projection area of the particle.

The average diameter of the primary and the secondary particles are determined by calculating average of diameter of the optionally selected 100 particles measured by the observation of the cross section and the surface of the porous layer by the electron micrometer. The diameter of individual particle is represented by the diameter of a circle having the area the same as the projection area of the particle. The average diameter of the secondary particles is preferably not more than 300 nm from the viewpoint of permeation of the ionizing radiation.

It is also preferable that the gas phase-method silica is stood for 3 or more days under a humidity of from 20 to 60% for controlling the moisture content of the gas phase-method silica. The ratio of the isolated silanol group is preferably from 0.5 to 1.5, and more preferably from 0.5 to 1.1.

Alumina

Alumina is a aluminum oxide and a hydrate thereof, and crystalline one and amorphous one are also usable. Ones each having a shape of irregular, sphere, planar or needle may be used. Particularly, planar alumina hydrate having an aspect ratio of not less than 2 and the average diameter of primary particles of from 5 to 30 nm, and a gas phase-method alumina are preferred.

The content of the inorganic particles in an aqueous coating liquid is from 5 to 40%, and particularly preferably from 7 to 30% by weight.

Hydrophilic Resin Crosslinkable by Ionizing Radiation

The hydrophilic resin crosslinkable by ionizing radiation is a water-soluble resin capable of occurring reaction to form crosslinks by irradiation of ionizing radiation such as ultraviolet rays and electron rays, which is water soluble before the hardening reaction and is become to substantially water-insoluble after the hardening reaction. Such the resin, however, has a certain degree of hydrophilicity and holds sufficient ink affinity after the hardening reaction.

As such the resin, a resin crosslinking group modified resin capable of occurring crosslinking reaction by light through the modified group, which is prepared by reacting poly(vinyl alcohol) (PVA) with a modifying group such as a photo-dimerization type, a photo-decomposition type, a photo-depolymerization type, a photo-modification type and a photo-polymerization type groups, and a resin directly crosslinkable by electron rays are usable. Among them, the photo-dimerizable type and photo-polymerizable type resins are preferred.

As the photo-dimerizable type ionizing radiation crosslinkable resin, ones each introduced with a diazo group, a cinnamoyl group, a stilbazonium group or a stilquinolium group are preferable.

Examples of the hydrophilic resin crosslinkable by the ionizing radiation include a random copolymer of one having the following structure (a) or (a′) with a PVA compound.

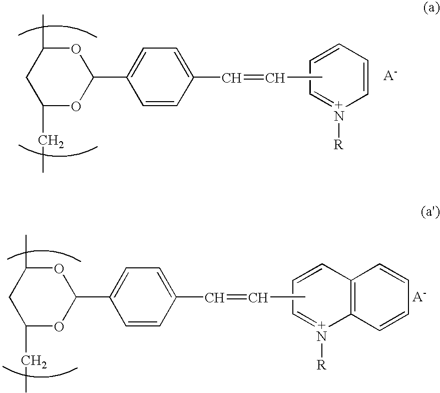

In the above formula, R is a hydrogen atom or an alkyl group, A⁻ is an anion such as a halide ion, a sulfate ion, a phosphate ion, a p-toluenesulfonate ion, a methylsullfate ion and a hydroxyl ion.

Furthermore, as the ionizing radiation crosslinkable hydrophilic resin, a hydrophilic resin having a saponification product of poly(vinyl acetate) containing the structural unit represented by the following Formula (1) as the main skeletal structure is usable.

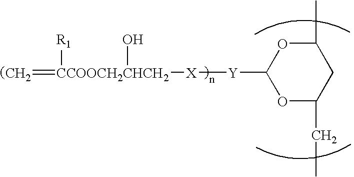

In the above formula, R₁ is a hydrogen atom or an alkyl group, X is a —OCO(CH₂)ₘO— group, Y is an aromatic ring or a simple bond, n is an integer of 1 or 2 and m is an integer of from 0 to 6.

In such the hydrophilic resin, the polymerization degree of the PVA as the mother nucleus is preferably not less than 500, and more preferably from 1,700 to 4,500.

The modifying ratio of the ionizing radiation reactive crosslinking group to the segment is preferably not more than 4 mole-percent, and more preferably from 0.1 to 1 mole-percent.

Examples of the hydrophilic resin crosslinkable by the ionizing radiation are shown below, but the invention is not limited thereto.

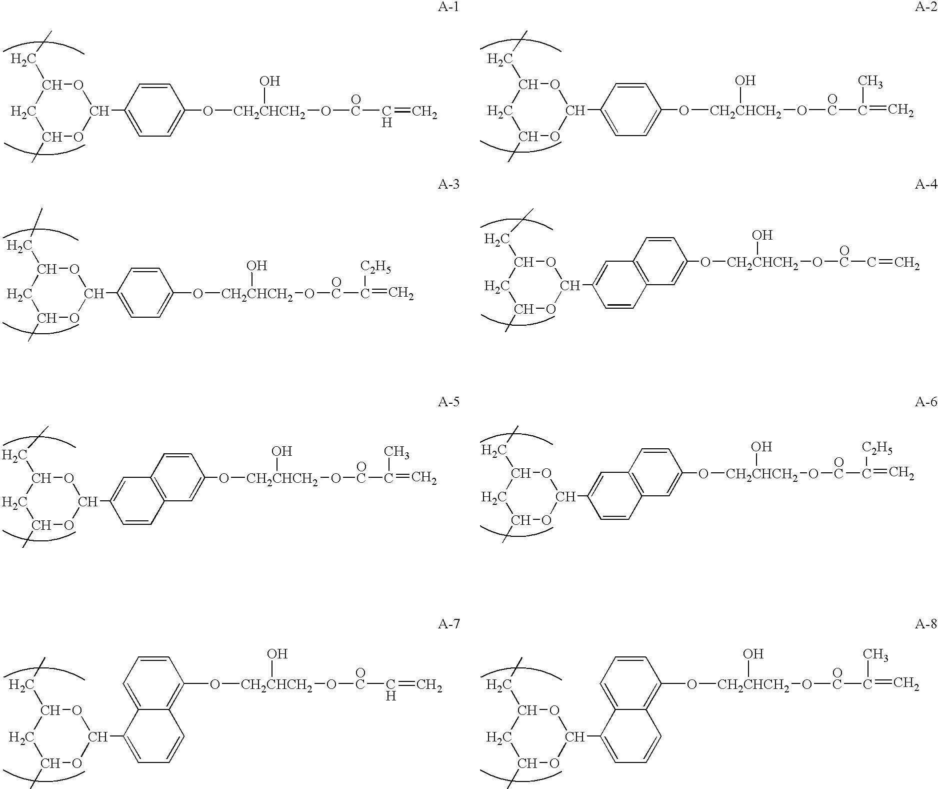

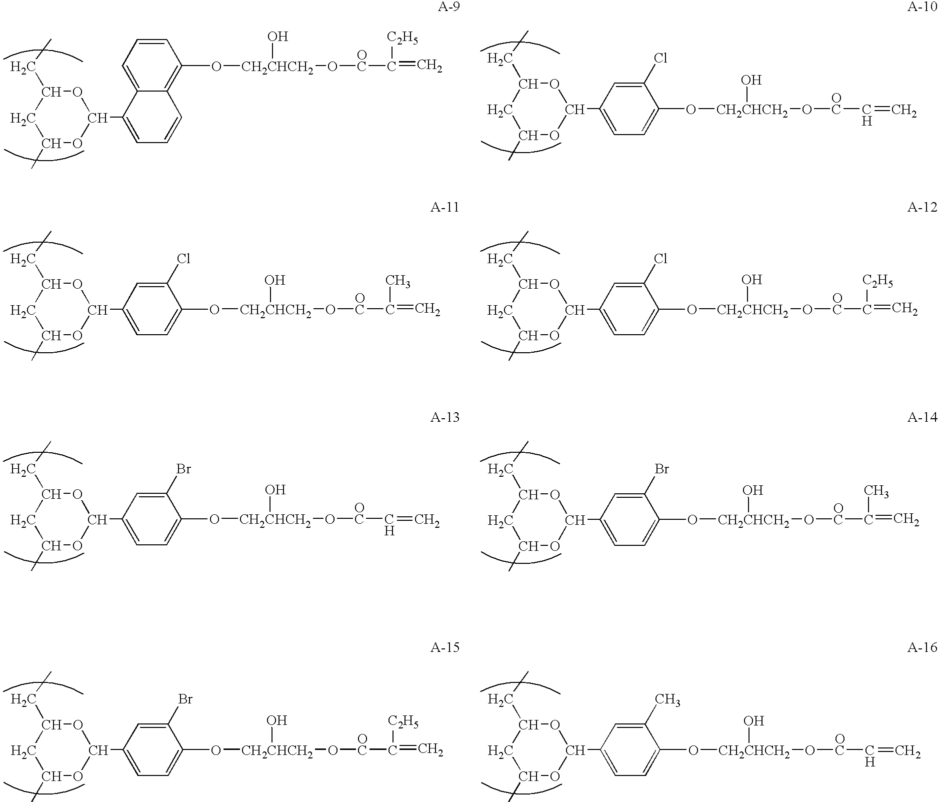

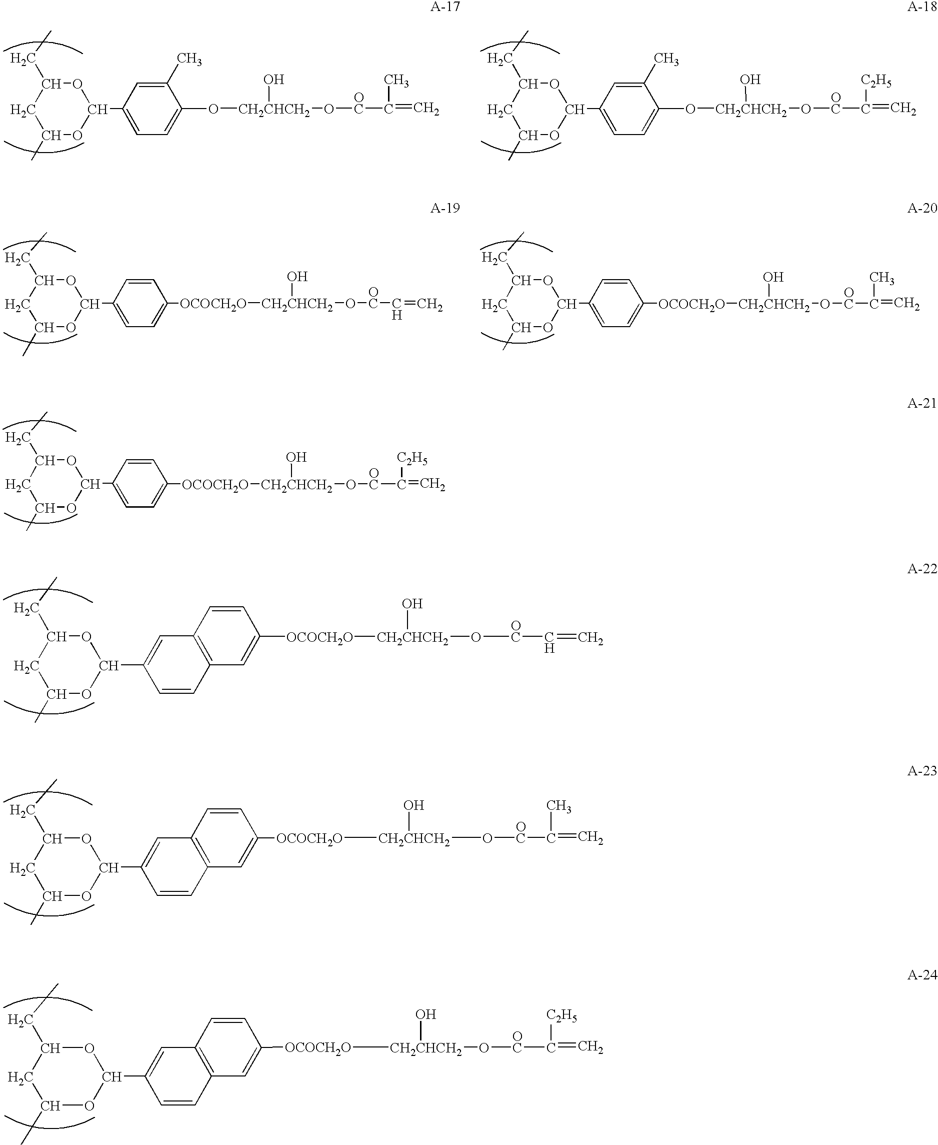

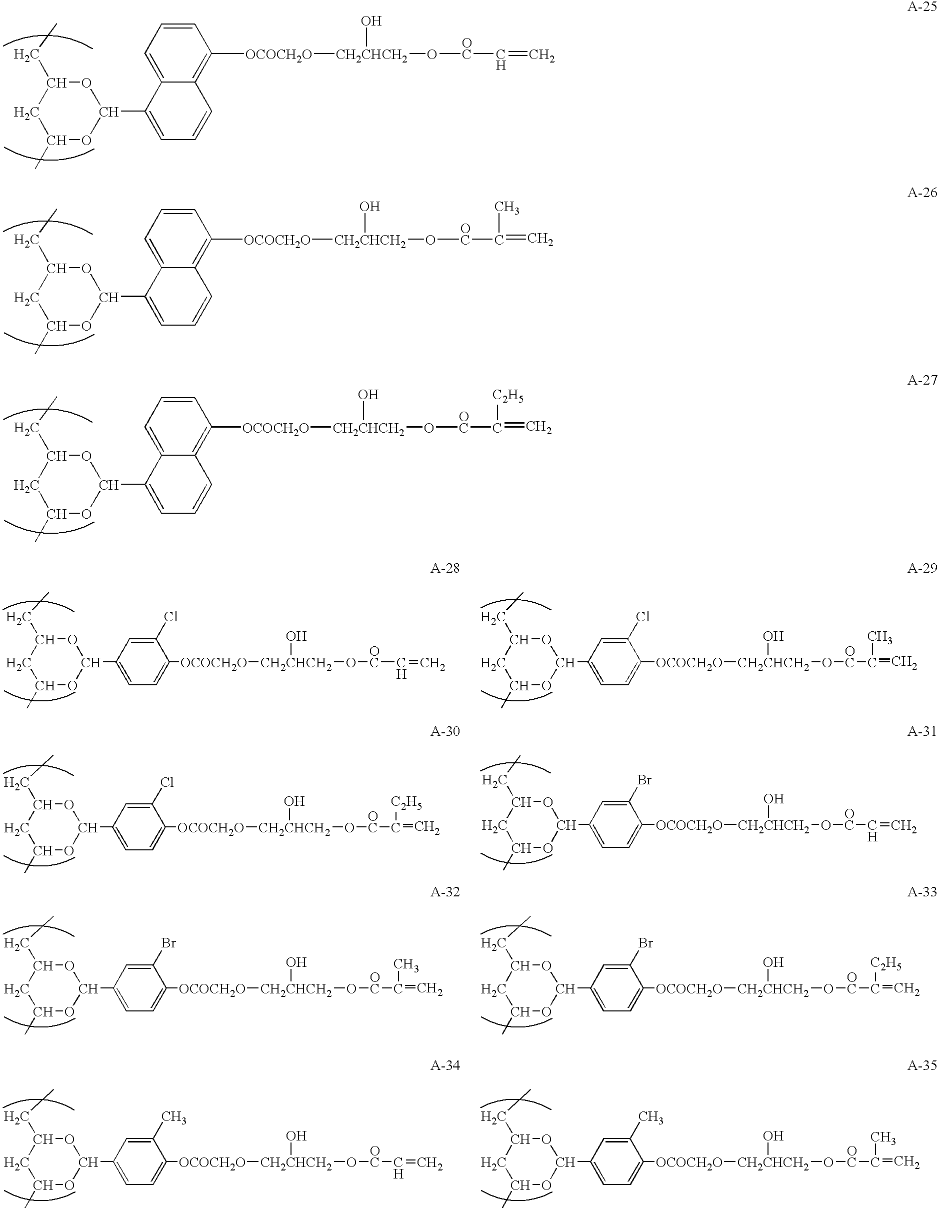

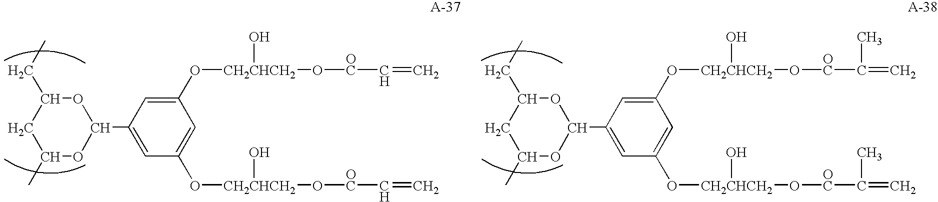

When the polymerization degree is less than 500 or the modifying ratio exceeds 4 mole-percent, the density of crosslink is made too high and the resistivity to the break by bending of the coated layer is considerably degraded. Moreover, when the density of crosslink is too high, the balance of the hygroscopicity and the dimensional stability between the coated layer and the support is come not suitable so that the curling property is degraded.

F/B

The ratio F/B of the inorganic fine particle F to the crosslinked hydrophilic resin B in the porous layer is preferably from 2 to 50 times by weight. When the weight ratio is not less than 2 times, the porosity of the porous layer is satisfactory and sufficient pores capacity can be easily obtained, and it is avoided that the excessively crosslinked hydrophilic resin is swollen so as to block the pores on the occasion of the ink-jet recording. Besides, when the F/B is not more than 50, it is preferred that the cracks are difficultly formed on the occasion of the thick porous layer is coated. The F/B ratio of from 5 to 20 is particularly preferred. The ratio of from 5 to 15 is particularly preferred from the viewpoint of the resistivity to the break by bending of the dried coated layer.

In the invention, the porous layer preferably has a volume per unit area of the coated layer of 15 to 40 ml/m². The volume is defined by the volume of bubbles formed by immersing the recording paper in water, the volume of water capable of being absorbed by the coated layer, or the volume of transferred liquid during the contact time of 2 seconds when the finally obtained recording paper is subjected to measurement according to the test method of liquid absorbability of paper and paper board (Bristow method) prescribed by J. TAPPI 51.

Support

As the support to be used in the ink-jet recording paper, the water absorbable support such as paper and the water non-absorbable support such as resin film are usable, and the water non-absorbable support is preferable from the viewpoint of that a higher quality print can be obtained.

Examples of the water non-absorbable support include a polyester film, a diacetate film, a triacetate film, a polyolefin film, an acryl film, a polycarbonate film, a poly(vinyl chloride) film, a polyimide film, a transparent or opaque film composed of cellophane or celluloid, and a resin coated paper so called as RC paper composed of base paper coated by polyolefin resin layer on the both sides.

When the aqueous coating liquid is coated on the support, it is preferable that a subbing treatment or a corona discharge treatment is applied to the support to strengthen the adhesion between the surface of the support and the coated layer. The ink-jet recording paper may have a colored support.

The support preferably to be used in the invention is a transparent or opaque polyester film, an opaque polyolefin resin film and a paper support laminated by polyolefin resin on both sides thereof.

The paper support laminated by polyethylene, typical example of the polyolefin, is described below.

The raw paper to be used in the paper support is made by using wood pulp as the principal raw material, and synthesized pulp of polypropylene or synthesized fiber such as nylon and polyester may further be used according to necessity. As the wood pulp, for example, LBPK, LBSP, NBKP, NBSP, LDP, NDP, LUKP and NUKP are also usable, and LBKP, NBSP, LBSP, NDP and LDP are used in the major amount, which is wealthy in short fibers. Provided, it is preferable that the ratio of LBSP or LDP is used in an ratio of from 10 to 70% by weight. A chemical pulp such as sulfate pulp and sulfite pulp containing few impurities is preferably used, and pulp improved in the whiteness by a bleaching treatment is also suitable.

In the raw paper, the followings may be optionally added: a sizing agent such as a fatty acid and an alkylketen dimmer, a white pigment such as calcium carbonate, talk and titanium oxide, paper strengthening agent such as starch, polyacrylamide and poly(vinyl alcohol), a fluorescent whitening agent, a moisture holding agent such as poly(ethylene glycol), a dispersant and a softening agent such as a quaternary amine.

The freeness of pulp utilized in paper making is preferably from 200 to 500 ml according to the prescription of CSF. Regarding the fiber length of the pulp after beating, it is preferable that the sum of the weight percent of the remains of the 24 mesh sieve and that of the 42 mesh sieve according to the prescription of JIS P 8207 is from 30 to 70% by weight. The remains of 4 mesh sieve are preferably not more than 20% by weight.

The weight of the raw paper is preferably from 30 to 250 g, and more preferably from 50 to 200 g. The thickness of the raw paper is preferably from 40 to 250 μm. The raw paper may be subjected to a calendar treatment for providing high smoothness in the course of or after the paper making. The density of the raw paper is usually from 0.7 to 1.2 g/m² according to the prescription of JIS P 8118. The stiffness of the raw paper is preferably 20 to 200 g under the condition according to the prescription of JIS P 8143.

A surface sizing agent may be coated on the surface of the raw paper. As the surface sizing agent, ones the same as the sizing agent to be added in the paper may be used. The pH of the raw paper is preferably from 5 to 9 when the measurement is performed by the hot water extraction method according to JIS P 8113.

Although the polyethylene for covering the surface and back surface of the raw paper is principally a low density polyethylene (LDP) or a high density polyethylene (HDPE); LLDP and polypropylene may be partially used other than the above.

It is preferable that the polyethylene layer to be laminated on the surface, on which the coating layer is provided, is improved in the opaqueness and whiteness by adding rutile type or anatase type titanium oxide as widely applied as in the photographic paper. The content of the titanium oxide is from 1 to 20%, and preferably from 2 to 15%, by weight of the polyethylene.

The polyethylene laminated paper may be used as a glossy paper, and as one having a fine grain surface such as a matted surface and a linen surface such as that usually used in the photographic paper by an embossing treatment on the occasion of the coating of the polyethylene by extrusion onto the raw paper surface.

The using amount of the polyethylene on the front or back surface is decided according to the thickness of the aqueous coating composition, and so that the curling is optimized under low and high humidity after provision of the back layer. The polyethylene layer on the side on which the aqueous coating composition is to be coated is preferably from 20 to 40 μm and that on the back layer side is preferably from 10 to 30 μm.

It is preferable that the polyethylene laminated paper has the following properties. 1) Tensile strength: from 20 to 300 N in the longitudinal direction and from 10 to 200 N in the lateral direction according to JIS P 8113

2) Tear strength: from 0.1 to 2 N in the longitudinal direction and from 0.2 to 2 N in the lateral direction according to JIS P 8116

3) Compressive elasticity: 1030 N/cm² or more

4) Beck smoothness of the surface: 500 seconds or more as to the glossy surface under the condition prescribed in JIS P 8119, in the case of the embossed surface, smoothness lower than the above is accepted.

5) Beck smoothness of the back surface: from 100 to 800 seconds or more under the condition prescribed in JIS P 8119

6) Opaqueness: transmittance of the visible light of not more than 20%, particularly not more than 15%, when measured under the condition of specular light incidence/diffuse light transmission

7) Whiteness: 90% or more according to Hunter whiteness=−5 to +5, b*=−10 to +5 when measured by JIS Z 8722 (without fluorescent agent) or JIS Z 8717 (with fluorescent agent) and represented by the color representing method according to JIS Z 8730

It is preferable to provide a subbing layer on the ink accept layer side of the support for improving the adhesiveness with the ink accept layer. As the binder of the subbing layer, a hydrophilic polymer such as gelatin and PVA, and a latex polymer having a Tg of from −30° C. to 60° C. are preferable. These binders are used in an amount of from 0.001 g to 2 g pre square meter. Small amount of an antistatic agent such as a know cationic polymer may be contained in the subbing layer for preventing static charge.

A backing layer may be provided on the surface opposite to the ink accept layer for improving the sliding property and the static charging ability. As the binder of the backing layer, a hydrophilic polymer such as gelatin and PVA, and a latex polymer having a Tg of from −30° C. to 60° C. are preferable, and an antistatic agent such as a cationic polymer, various kinds of surfactant, and a matting agent having an average particle diameter of from about 0.5 to 20 μm may also be added. Although the thickness of the backing layer is approximately from 0.1 to 1 μm; the thickness is approximately from 1 to 20 μm when the backing layer is provided for preventing the curling. The backing layer may be constituted by two or more layers.

It is preferable to apply a surface treatment such as a corona treatment and a plasma treatment when the subbing layer or backing layer is provided.

Various Additives

In the aqueous coating liquid constituting the porous layer, various additives may be added. Examples of the additives include a cationic mordant, a crosslinking agent, a surfactant including cationic, anionic, nonionic and amphoteric ones, a background tone controlling agent, a fluorescent whitening agent, a mold preventing agent, a viscosity controlling agent, a low-boiling solvent, a high-boiling solvent, a latex emulsion, a discoloring preventing agent, a UV absorbent, a polyvalent metal compound including water-soluble and water-insoluble ones, a matting agent and a silicone oil. Among them, the cationic mordant is preferred for improving the water resistivity and the humidity resistivity of the printed image.

As the cationic mordant, a polymer mordant having a primary, secondary or tertiary amino group or a quaternary ammonium group is usable, and the polymer mordant having the quaternary ammonium group is preferred since the discoloration and the degradation of the light fastness of image is made small and sufficient mordant effect can be obtained by such the mordant.

The preferred mordant can be obtained as a homopolymer of the monomer having the quaternary ammonium group or a copolymer of a co-condensation product of such the monomer with another monomer.

Water-Soluble Polyvalent Metal Compound

As the polyvalent metal compound, for example, sulfate, chloride, nitrate or acetate of Mg²⁺, Ca ²⁺, Zn ²⁺, Zr ²⁺, Ni²⁺ or Al³⁺ are usable. Moreover, an inorganic polymer such as basic poly(aluminum hydroxide) and zirconium acetate is included in the preferred water-soluble polyvalent metal compounds. These compounds mostly have the effects of raising the light fastness, spreading resistivity and moisture resistivity of the image. These water-soluble polyvalent metal ions are each used in an amount of from approximately 0.05 to 20 millimoles, and preferably from 0.1 to 10 millimoles, per square meter of the recording paper.

Coating Method

The method for coating the coating liquid can be optionally selected from known coating methods. For example, a gravure coating method, roller coating method, rod bar coating method, air-knife coating method, spray coating method extrusion coating method and curtain coating method are usable; and the extrusion coating method using the slide hopper described in U.S. Pat. No. 2,681,294 is preferably used.

The porous layer of the recording paper may be either a single layer or a multi-layer. In the case of the muti-layer structure, it is preferable that the whole layers are simultaneously coated from the viewpoint of the cost reducing.

Ionizing Radiation

In the invention, the usable ionizing radiation includes, for example, electron rays, UV rays, α-rays, β-rays, γ-rays and X-rays; and UV rays are preferred which have low dangerousness to the human body and easiness of handling and are widely spread in the fields of industry.

As the light source, for example, a low pressure, medium pressure or high pressure mercury lamp having an operation pressure of from 700 to 10⁶ Pa, and a metal halide lamp are used. The high pressure mercury lamp and the metal halide lamp are preferable, and the metal halide lamp is more preferable, from the viewpoint of the spectral distribution of the light. A filter for cutting the light of not more than 300 nm is preferably provided.

In the invention, the ionizing radiation with an illuminance of from 0.1 mW/cm² to 1W/cm² is irradiated when the concentration of the solid components in the coated layer is within the range of from 5 to 90%. When the illuminance exceeds 1 W/cm², the surface hardness of the layer is raised but the hardness at the deep portion of the layer is lowered and the layer hardened only at the outer surface is resulted. In such the case, the balance of hardness in the deepness direction in the layer is lost, and undesirable curling is caused. When the illuminance is lower than 0.1 W/cm², the crosslinking reaction is not sufficiently progressed and the effect of the invention cannot be obtained.

The output of the ionizing radiation is preferably from 60 W/cm to 400 W/cm, and more preferably from 70 W/cm to 180 W/cm.

The illuminance of the ionizing radiation is preferably from 10 mW/cm² to 1 W/cm², more preferably from 50 mW/cm² to 1 300 mW/cm² and most preferably from 100 mW/cm² to 1 250 mW/cm².

In the invention, the total irradiation energy of the ionizing radiation is preferably from 0.1 to 1 J/cm², more preferably from 0.1 to 100 J/cm², and particularly preferably from 1 to 50 J/cm².

When UV rays contains rays having a wavelength of less than 300 nm or the total irradiation energy exceeds 100 J/cm², the mother nuclei of the ionizing radiation hardenable resin or the additives contained in the layer are decomposed by the UV rays so that the effects of the invention can not obtained and a problem of odor caused by the decomposed product is possibly raised. Besides, when the irradiation energy is less than 0.1 J/cm², the crosslinking efficiency is made insufficient and the effect of the invention cannot be obtained.

In the invention, the ionizing radiation with an illuminance of from 0.1 mW/cm² to 1W/cm² is irradiated when the concentration of the solid components in the coated layer is within the range of from 5 to 90%. When the solid components concentration is less than 5%, it is not preferable that the contacting probability of the reaction species is lowered and the reaction is not effectively progressed. When the concentration is more than 95%, the mobility of the reaction species is inhibited so that the reaction is not effectively progressed. In the invention, the preferable range is from 8 to 60%, more preferable range is from 10 to 45%.

The presence of the preferable range of the illuminance for applying the same total irradiation energy is caused by the change of the transmittance of light. The density distribution of the reaction species is changed depending on the transmittance of the UV rays. When the illuminance of UV rays is high, high concentration of the reaction species is generated at the surface layer and a hard and dense layer is formed at the outer surface of the coated layer.

When the illuminance is within the preferable range, loose crosslinks are uniformly formed in the deep direction since the degree of the crosslinking at the surface is low and the transmittance of the light into the deep direction of the layer is high. When the illuminance is too low, it is not preferred that a prolonged time is required to apply the prescribed total irradiation energy. Thus a disadvantage on the cost of equipment occurs. Moreover, it is not preferable that the absolute amount of light is made insufficient by scattering of UV rays by the coated layer.

Photopolymerization Initiator, Sensitizer

In the recording paper, a photopolymerization initiator, hereinafter referred to as an initiator also, and a sensitizer are preferably added. These compounds may be added in the state of dissolved or dispersed in a solvent or bonded with the photosensitive polymer. As the initiator and the sensitizer, known compounds can be used without any limitation.

Examples of the usable initiator and the sensitizer include a benzophenone such as benzophenone, hydroxybenzophenone, bis-N,N-dimethylaminobenzophenone, bis-N,N-diethylaminobenzophenone and 4-methoxy-4′-dimethylaminobenzophenone; a thioxanthone such as thioxanthone, 2,4-diethylthioxanthone, i-propylthioxanthone, chlorothioxanthone and i-propoxychlorothioxanthone; an anthraquinone such as anthraquinone, benzanthraquinone, aminoanthraquinone and chloroanthraquinone; an acetophenone; a benzoin ether such as benzoin methyl ether; a 2,4,6-trihalomethyltriazine; a 1-hydroxycyclohexyl phenyl ketone; a dimmer of 2,4,5-triarylimidazole such as dimmer of 2-(o-chlorophenyl)-4,5-diphenylimidazole, dimmer of 2-(o-chlorophenyl)-4,5-di(m-methoxyphenyl)imidazole, dimmer of 2-(o-fluorophenyl)-4,5-phenylimidazole, dimmer of 2-(o-methoxyphenyl)-4,5-phenylimidazole, dimmer of 2-(p-mrthoxyphenyl)-4,5-diphenylimidazole, dimmer of 2-di(p-methoxyphenyl)-5-phenylimidazole and dimmer of 2-(2,4-dimethoxyphenyl)-4,5-diphenylimidazole; benzyldimethylketal, 2-benzyl-2-dimethylamino-1-(4-morpholinophenyl)-butane-1-one, 2-methyl-1-[4-(methylthio)phenyl]-2-morpholino-1-propanone, 2-hydroxy-2-methyl-1-phenyl-propane-1-one, 1-[4-(2-hydroxyethoxy)-phenyl]-2-hydroxy-2-methyl-1-propane-1-one, phenanthrenequinone, 9,10-phenanthrenequinone; a benzoin such as methylbenzoin and ethylbenzoin; a acrydine derivative such as 9-phenylacrydine and 1,7-bis(9,9′-acrydinyl)heptane; and anbisacylphosphine oxide and their mixture. The above-mentioned may be used singly or in combination.

Additionally to the initiator, an accelerator may be added. Examples of the accelerator include ethyl p-diaminoethylbenzoate, i-amyl p-dimethylaminobenzoate, ethanolamine, diethanolamine and triethanolamine.

### EXAMPLES

The invention is described referring examples below but the invention is not limited thereto. In example, percent (%) is percent by weight as long as a specific description is not attached.

Preparation of Silica Dispersion S

Forty kilograms of a previously uniformly dispersed silica dispersion containing 30% gas phase-method silica Aergel 200, produced by Nihon Aerogel Co., Ltd., having an average diameter of primary particles of 0.012 μm, further containing 0.5% of ethanol and having a pH of 2.6 was added into 11 kg of a solution containing 12% of a cationic polymer dispersing agent P-1, 10% of n-propanol, 2% of methanol, 2% of antifoaming agent SN-381, produced by Sannobco Co., Ltd., and having a pH of 2.5, while stirring at 3,000 rpm at room temperature. Then the mixture was dispersed under a pressure of 3,000 N/cm² using a high pressure homogenizer manufactured by Sanwa Kogyo Co., Ltd., and was finished by purified water so as to make the silica content to 20%. Thus Silica Dispersion S was obtained.

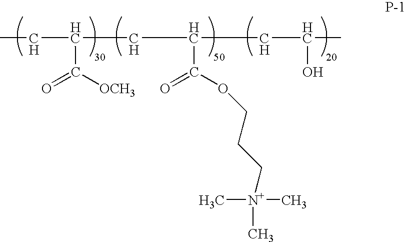

Preparation of Recording Paper 1

Into 100 g of thus obtained Silica Dispersion S, 40 g of a solution of UV crosslinkable PVA derivative A-2 with a main chain PVA polymerization degree of 3.000, saponificated degree of 88% and crosslinking group modified ratio of 1 mole-%, containing 20% of i-propyl alcohol, and 0.05 g of a Photopolymerization initiator Irgacure 2959 were gradually added while stirring. Then the mixture was finished by purified water so as to make the solid component concentration to 10%. Thus Coating Liquid T-1 was prepared.

Coating Liquid T-1 was coated by a bar coater on polyethylene coated paper composed of raw paper which has a thickness of 170 μm and is coated with polyethylene on the both sides so that the coated amount the solid component was made to be 17 g m². In the polyethylene coated paper, the polyethylene coated on the ink accept layer side contained 8% of anatase type titanium oxide, and 0.05 g/m² of gelatin subbing layer was coated on this side. A latex of polymer having a Tg of about 80° C. was coated on the opposite side as a backing layer. Then the coated layer was irradiated by light having a principal wavelength at 365 nm radiated by a metal halide lamp. The illuminance of the UV rays was 90 mW/cm² at 365 nm and the total irradiation energy was 100 mJ/cm². Thereafter, the coated layer was dried at 50° C. in a hot wind oven to obtain Ink-jet Recording Paper 1.

Preparation of Recording Paper 2

Recording Paper 2 was prepared in the same manner as in

Recording paper 1 except that the solid component concentration in the coating liquid was changed to 15% and the irradiation illuminance and the total irradiation energy of the UV rays were each changed to 240 mW/cm² and 100 mJ/cm², respectively.

Preparation of Recording Paper 3

Recording Paper 3 was prepared in the same manner as in Recording paper 1 except that the solid component concentration in the coating liquid was changed to 7.5% and the irradiation illuminance and the total irradiation energy of the UV rays were each changed to 110 mW/cm² and 90 mJ/cm², respectively.

Preparation of Recording Paper 4

Recording Paper 4 was prepared in the same manner as in Recording paper 1 except that the irradiation illuminance and the total irradiation energy of the UV rays were each changed to 150 mW/cm² and 280 mJ/cm², respectively.

Preparation of Recording Paper 5

Recording Paper 5 was prepared in the same manner as in Recording paper 1 except that the coating liquid T-1 was coated so that the coated amount of the solid component was to be 17 g/m² and dried at 50° C. in the hot wind oven until the solid component concentration was come to 80%, and then irradiated by UV rays of a illuminance of 110 mW/cm² and a total irradiation energy of 48 mJ/cm².

Preparation of Recording Paper 6

Recording Paper 6 was prepared in the same manner as in Recording paper 1 except that the irradiation of UV rays was omitted.

Preparation of Recording Paper 7

Recording Paper 7 was prepared in the same manner as in Recording paper 1 except that the coating liquid T-1 was coated so that the coated amount of the solid component was to be 17 g/m² and dried at 50° C. in the hot wind oven until the solid component concentration was come to 98%, and then irradiated by UV rays of a illuminance of 100 mW/cm² and a total irradiation energy of 50 mJ/cm².

Evaluation of Recording Paper

Above-prepared recording papers were evaluated on the appearance of layer surface, glossiness at 60°, ink absorbability, resistivity to break by bending and dimensional stability according to the following procedures. Results of the evaluation are listed in Table 1.

<Surface Appearance>

The smoothness of the surface and the number of crack in 10 cm² of the surface were visually evaluated.

<Ink Absorbability>

A patch was uniformly printed by output of cyan and yellow of each 255 using an ink-jet printer PM900C manufactured by Seiko Epson Co., Ltd., and the unevenness of the printed image was visually evaluated according to the following 10 ranks.

1: Unevenness of the image was not observed.

2: Unevenness was slightly observed on the image by careful observation; this level of the unevenness did not cause problem in the practical use.

3: Dot shaped unevenness was observed; this level of the unevenness caused little problem in the practical printing.

4: Unevenness of the image was observed; this level of the unevenness almost did not cause any problem in the practical printing.

5: Unevenness of the image was observed; this level of the unevenness on this level almost did not cause any problem in the practical printing according to the kind of the image.

6: Unevenness of color was observed; this level of the unevenness was not acceptable for practical use.

7: The ink was flowed to form an island like pattern; this level of the unevenness was not acceptable for practical use.

8: The ink was over flowed and the color contamination occurred; this level of the unevenness was not acceptable for practical use.

9: Over flowed ink was difficultly dried; this level of the unevenness was not acceptable for practical use.

10: The level of the printed situation was acceptable for practical use at all.

In the above, samples ranked 6 or lower have no commercial value.

<Resistivity to Break by Bending>

The recording paper cut into a rectangular shape of 5 mm×10 cm was put round on a paper tube having a inner diameter of 3 cm and breaking formed by bend was visually observed and ranked into 5 ranks.

A: No breaking was formed.

B: Number of the breaking was 3 or less.

C: Number of the breaking was 5 or less.

D: Number of the breaking was from 6 to 20.

E: Number of the breaking was from 20 to 100.

F: Number of the breaking was more than 100.

<Dimension Stability>

The recording paper was cut into A4 size and stood on a horizontal stand for one day under a condition of a temperature of 23° C. and a relative humidity of 20%, and the rising up of the four corners caused by curling of the paper were measured and the averaged value of the measured results in mm was defined as the dimensional stability according to the following norms. Each of the recording papers was stood so that the ink accept layer surface was upward and the four corners of it rose up.

A: Less than 2 mm

B: Not less than 2 mm and less than 5 mm

C: Not less than 5 mm and less than 10 mm

D: Not less than 10 mm and less than 30 mm

E: Not less than 30 mm

F: The measurement was impossible since the sample was rolled up.

Results are shown in Table 1.

TABLE 1

| Re- | | | | | Dimen- | |
|---|---|---|---|---|---|---|
| cord- | | | Ink | Resistivity | sional | |
| ing | Surface | | absorb- | to break by | sta- | |
| paper | appearance | Cracks | ability | bending | bility | |
| 1 | Smooth | 0 | 1 | A | B | Inv. |
| 2 | Smooth | 0 | 1 | A | A | Inv. |
| 3 | Smooth | 0 | 2 | A | B | Inv. |
| 4 | Smooth | 0 | 1 | B | B | Inv. |
| 5 | Smooth | 0 | 1 | A | A | Inv. |
| 6 | Waved with | 166 | 8 | E | D | Comp. |
| | long cycle | | | | | |
| 7 | Waved with | 156 | 6 | D | D | Comp. |
| | long cycle | | | | | |

Inv.: Inventive
Comp.: Comparative

It is understood from Table 1 that the recording papers according to the invention are superior to the comparative recording papers in the all evaluation items.

It is to be noted that various changes and modifications will be apparent to those skilled in the art. Therefore, unless such changes and modifications depart from the scope of the present invention, they should be construed as being included therein.

What is claimed is:

1. A method for producing an ink-jet recording sheet comprising the steps of:
(a) coating a liquid coating composition on a support so as to obtain a coated layer, the liquid coating composition containing,
(i) inorganic microparticles; and
(ii) a hydrophilic resin;
(b) irradiating the coated layer with ionization radiation, wherein illumination intensity of the ionization radiation is in a range of 0.1 to 1000 mW/cm² so as to cross-link the hydrophilic resin when a density of a solid portion in the coated layer is in a range of 5 to 90 weight % based on the total weight of the coated layer; and
(c) drying the coated layer.

2. The method of claim 1, wherein the illumination intensity of the ionization radiation is in a range of 50 to 300 mW/cm².

3. The method of claim 1, wherein the ionization radiation is ultraviolet rays.

4. The method of claim 1, wherein a total irradiation energy of the ionization radiation is in a range of 0.1 to 1000 mJ/cm².

5. The method of claim 2, wherein the ionization radiation is ultraviolet rays.

6. The method of claim 5, wherein a total irradiation energy of the ionization radiation is in a range of 0.1 to 1000 mJ/cm².

7. An ink-jet recording sheet comprising a support and a porous ink receptive layer provided on the support, the porous ink receptive layer which contains inorganic microparticles and a cross-linked resin,
wherein the porous ink receptive layer is prepared by a method comprising the steps of:
(a) coating a liquid coating composition on the support so as to obtain a coated layer, the liquid coating composition containing,
(i) inorganic microparticles; and
(ii) a hydrophilic resin;
(b) irradiating the coated layer with ionization radiation, wherein illumination intensity of the ionization radiation is in a range of 0.1 to 1000 mW/cm² so as to cross-link the hydrophilic resin when a density of a solid portion in the coated layer is in a range of 5 to 90 weight % based on the total weight of the coated layer; and
(c) drying the coated layer.

8. The ink-jet recording sheet of claim 7, wherein the illumination intensity is in a range of 50 to 300 mW/cm².

9. The ink-jet recording sheet of claim 7, wherein a polymerization degree of the hydrophilic resin acetate is not less than 500, and a ratio of cross-linking conversion of the hydrophilic resin is not more than 4 mol % based on the total mol of the hydrophilic resin in the coated layer.

10. The ink-jet recording sheet of claim 7, wherein the ionization radiation is ultraviolet rays.

11. The ink-jet recording sheet of claim 7, wherein the total irradiation energy of the ionization radiation is in a range of 0.1 to 1000 mJ/cm².

12. The ink-jet recording sheet of claim 8, wherein the ionization radiation is ultraviolet rays.

13. The ink-jet recording sheet of claim 12, wherein a polymerization degree of the hydrophilic resin acetate is not less than 500,and a ratio of cross-linking conversion of the hydrophilic resin is not more than 4 mol % based on the total mol of the hydrophilic resin in the coated layer.

14. The ink-jet recording sheet of claim 13, wherein the total irradiation energy of the ionization radiation is in a range of 0.1 to 1000 mJ/cm².
